(19) United States
(12) Patent Application Publication
(10) Pub. No.: US 2006/0206721 A1
(43) Pub. Date: Sep. 14, 2006

(54) Circuit provided with a secure external access

(75) Inventors: Arnaud Dahamel, LA CIOTAT (FR); Bruno Bernard, Roquefort La Bedoule (FR); Frank Lhermet, La Ciotat (FR)

Correspondence Address: BUCHANAN, INGERSOLL & ROONEY PC, POST OFFICE BOX 1404, ALEXANDRIA, VA, 22313-1404, US

(73) Assignee: INNOVA CARD, LA CIOTAT (FR)

(21) Appl. No.: 10/549,850

(22) PCT Filed: Mar. 24, 2004
(86) PCT No.: PCT/FR04/00718

§ 371 Date: Sep. 23, 2005

(30) Foreign Application Priority Data
Mar. 24, 2003 (FR) 03/03522

(51) Int. Cl. H04L 9/00

(52) U.S. Cl. 713/185

(57) ABSTRACT

The invention relates to a circuit IC comprising an microprocessor MIC and a set of peripheral devices comprising at least one communication interface UMI for external access. The peripherals PER, unlike the communication interface UMI, are connected to the microprocessor MIC by an interconnection bus BUS. The circuit also comprises a security module CR connected to the interconnexion bus BUS and to the communication interface UMI by a dedicated link DL.

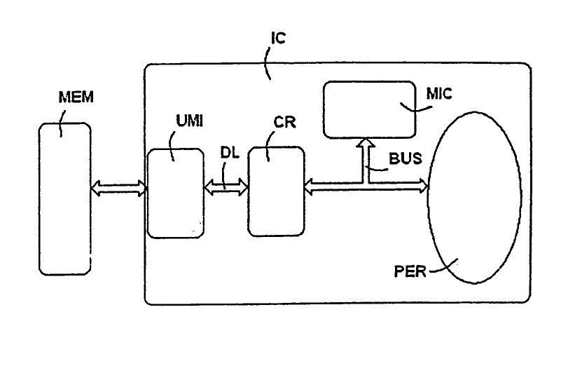

This invention relates to a circuit provided with a secure external access.

The invention relates to the field of programmable integrated circuits, mainly that of circuits used for conducting confidential transactions.

Such a circuit comprises a microprocessor and, in most cases, a cache memory, a cache memory controller and/or a memory management unit. It also generally includes a non-volatile memory, one or several working memories, such as Random-Access Memory (RAM) or Read-Only Memory (ROM). It also includes, in most cases, other peripheral devices suited for the applications that it is designed to implement.

On the other hand, the circuit comprises a communication interface for external access. In other words, this interface enables the microprocessor to exchange data with any component located outside the circuit.

The invention has a particularly advantageous application when this component is a memory. Indeed, it is common to attach an external memory to the integrated circuit so that the users of this circuit can avail of additional memory space.

It is obvious that the contents of the external memory can be accessed by the microprocessor, but they can also be accessed by any other piece of equipment. Thus, it is easy to read and even modify the data recorded in this memory. And yet, it is sometimes imperative for these contents to be protected from any intervention from outside the circuit. This is mainly the case when the memories contain security-related information, such as a confidential access code or verification of a digital signature.

When loading a program in the external memory, it is provided that the integrated circuit that receives this program from the outside verifies its authenticity (identity of the issuing party) and its integrity (that it has not been modified by any third parties) before saving it in the memory. This verification is normally carried out by means of an electronic signature protocol.

It is practically impossible to apply this protocol every time the external memory is read by the integrated circuit, since this is an operation that requires a considerable amount of processing power and is therefore very slow.

The object of the present invention is therefore to increase the protection of this memory against unwanted access.

According to the invention, a circuit comprises a microprocessor and a set of peripheral devices including at least one communication interface for external access, in which these peripheral devices, unlike the communication interface, are connected to the microprocessor by an interconnection bus; the circuit also comprises a security module connected to the interconnection bus and to the communication interface by a dedicated link.

According to a preferred embodiment of the circuit, the communication interface is adapted to an external memory.

Advantageously, the security module comprises encryption means CR.

Preferably, the encryption means should use a private key.

It is desirable for the encryption key to be longer than the standard length of the data processed by the microprocessor, therefore the latter comprises means for breaking encrypted words down into standard-length data.

If the circuit also comprises a cache memory associated to a controller, the security module is able to process the consecutive accesses of this controller in order to break the encrypted words down into standard-length data.

It is preferable for the encryption key to be stored in a one-time-programmable register, and this register can be saved in a non-volatile memory.

The present invention will be better understood with more detail in the context of the following description of a sample embodiment provided for illustrative purposes in reference to the appended figure, which shows a diagram of an integrated circuit according to the invention.

In reference to the figure, an integrated circuit IC comprises a microprocessor MIC that is possibly connected to a cache memory and/or to a memory controller (not shown). It also comprises a communication interface UMI and, generally, other peripheral devices PER, such as a non-volatile flash memory, working random-access memory, etc.

According to the invention, the circuit also comprises a security module CR. A system bus BUS interconnects all the elements in the circuit except the communication interface UMI, and a dedicated link DL connects this interface UMI to the security module CR.

Outside the circuit there is a component MEM that can communicate with the communication interface UMI, and the invention thus provides protection for the data that pass through this interface by means of the security module CR.

In this specific case, this component is an external memory MEM and the communication interface is preferably a universal memory interface UMI.

The security module CR can use various techniques for encoding or modifying the data it receives from the microprocessor MIC through the system bus BUS before transmitting the data thus encoded to the communication interface UMI so that they do not appear clearly in the external memory MEM. It is obvious that this module can decode the information when it reads the data in this external memory MEM in order to return them to the microprocessor MIC the same way as they were provided initially.

An advantageous solution consists in resorting to encryption means that are provided preferably by the security module CR.

Thus, the data are encrypted before being saved in the external memory MEM and they are then decrypted when they are read by the said memory before being sent over the system bus BUS.

It is therefore advisable to encode the data on the fly before storing them in the external memory MEM.

The microprocessor MIC can process 8-, 16- or 32-bit data. Currently, access to external data is granted using words with a standard length of 8, 16 or 32 bits. To secure such data requires 8-, 16- or 32-bit encryption respectively. In this case the encryption would be very vulnerable, practically inefficient, if known algorithms are used.

It is therefore desirable to choose an algorithm that works with 64-bit data, or even 128-bit whenever necessary. Selecting a standard algorithm makes it possible to avoid additional constraints while guaranteeing a maximum level of security.

Algorithms with a private key will be given preference since they require much less processing time than algorithms with public keys.

As an example, the following algorithms will be used:
AES (Advanced Encryption Standard), working with 128-bit keys and currently providing maximum security,
DES (Data Encryption Standard), working with 64-bit keys, known for being universally used in systems that are less demanding in terms of security,
3DES (Triple Data Encryption Standard), or
XDES (Extended Data Encryption Standard), the latter two algorithms are recommended for the most demanding systems in terms of security, while ensuring high encoding rates at a low cost.

The security module CR makes it possible to encrypt data that are longer than the standard length. This module is designed for processing 64- or 128-bit data, recorded as eight or sixteen 8-bit words, four or eight 16-bit words, or else two or four 32-bit words respectively in the external memory MEM, therefore access to any of these data is divided into several 8-, 16- or 32-bit accesses respectively.

For this purpose, the security module CR is able to process grouped or consecutive accesses of the microprocessor cache memory controller. This cache memory contains a partial copy of the external memory MEM, which is updated depending on the part of the program being run by the microprocessor MIC. Since the cache memory is very fast and very close to the microprocessor MIC, it generally allows for an improvement of the circuit's performance.

The data present in the cache memory is replaced by the cache controller in packets. These packets have a minimum size of four 32-bit words, regardless of the size of the data processed by the microprocessor MIC.

It must be noted here that the cache memory can also be used by the circuit for other purposes.

The controller can be required to write the data saved in the cache memory that relate to the external memory MEM in packets with a size that is a multiple of 64 bits.

The interface between the cache memory and the external memory MEM, which can only manage 8-, 16- or 32-bit accesses is set up in a simple manner, breaking a 64-bit access down into eight 8-bit accesses, four 16-bit accesses or two 32-bit accesses respectively.

In the case of 32-bit access, the DES or 3DES algorithm will be loaded every two 32-bit words, while the AES algorithm will be loaded every four 32-bit words. The data are loaded on the fly. In the case of “pipeline” processing of the AES algorithm, in other words when complete processing of a piece of data in one or several cycles is able to receive a new piece of data in each cycle, only the first access introduces a latency time in the total data transfer time.

The private key used by the algorithm is preferably stored in a so-called OTP register (One Time Programmable). If the integrated circuit IC is provided with a non-volatile flash memory, this register can be located there.

The example of an embodiment of the invention described above was chosen due to its concrete nature. It would not, however, be possible to exhaustively list all the possible embodiments of this invention. Particularly, all the described means can be replaced with equivalent means without departing from the scope of the present invention.

1-8. (canceled)

9. An integrated circuit comprising a microprocessor and a set of peripheral devices including at least one communication interface for external access, wherein said peripherals, unlike said communication interface, are connected to said microprocessor by an interconnection bus on which the data length is equal to the standard data length of the data processed by said microprocessor, said integrated circuit also comprising a security module connected to said interconnection bus and to said communication interface by a dedicated link,
wherein the length of the data processed by the security module is greater than the standard data length of the data processed by the microprocessor, and the integrated circuit further comprises means for adapting the length of the data processed by the security module to the standard data length.

10. A circuit according to claim 9, wherein said means for adapting the length of the data processed by the security module to the standard data length includes a cache memory, associated with the microprocessor and provided with a cache memory controller which, upon accessing the cache memory, causes it to transmit to the security module data having a length equal to the standard data length, whereby the processing of the data by the security module is performed on the fly.

11. A circuit according to claim 10, wherein, during the ciphering of the data by the security module, the cache memory prepares data having a length greater than the standard data length, whereby said data can be accepted at the input of the security module.

12. A circuit according to claim 11, wherein, during the deciphering of the data by the security module, the cache memory breaks the deciphered data available at the output of the security module, which has a length greater than the standard data length, into standard-length data.

13. A circuit according to claim 12, wherein the security module uses a secret key algorithm which processes data having a length of at least 64 bits, and wherein the standard length of the data processed by the microprocessor is less than 64 bits.

14. A circuit according to claim 13, wherein said secret key algorithm is the AES algorithm.
